(19) United States
(12) Patent Application Publication
(10) Pub. No.: US 2011/0122526 A1
(43) Pub. Date: May 26, 2011

(54) MANUFACTURING METHOD OF MAGNETIC RECORDING MEDIUM, MAGNETIC RECORDING MEDIUM, AND INFORMATION STORAGE DEVICE

(75) Inventors: Kenji Sato, Kanagawa (JP); Tsutomu Tanaka, Kanagawa (JP); Tsutomu Nishihashi, Shizuoka (JP); Tadashi Morita, Ibaraki (JP); Kazuhiro Watanabe, Shizuoka (JP)

(73) Assignee: ULVAC, INC., Chigasaki-shi, Kanagawa (JP)

(21) Appl. No.: 13/002,738

(22) PCT Filed: Jul. 16, 2009
(86) PCT No.: PCT/JP2009/062896

§ 371 Date: Feb. 4, 2011

(30) Foreign Application Priority Data
Jul. 22, 2008 (JP) 2008-188517

(51) Int. Cl. G11B 5/706; G11B 21/02; B32B 38/10

(52) U.S. Cl. 360/75; 360/135; 156/247; 428/848.5; G9B/21.003

(57) ABSTRACT

A manufacturing method of a magnetic recording medium includes: forming a magnetic film having an artificial lattice structure by laminating plural types of atomic layers alternately on a substrate; and separating dots, which forms a dot separation band by implanting an ion, to reduce saturation magnetization locally, into portions of the magnetic film other than plural portions of the magnetic film. Each of the plural portions is made into a magnetic dot in which information is to be magnetically recorded. The saturation magnetization of the dot separation band is smaller than that of the magnetic dot.

### TECHNICAL FIELD

The embodiments discussed herein are related to a bit-patterned type magnetic recording medium, a manufacturing method of the bit-patterned type magnetic recording medium, and an information storage device equipped with the bit-patterned type magnetic recording medium.

### BACKGROUND ART

A Hard Disk Drive (HDD) is currently the dominating information storage device as a mass storage device capable of high-speed data access and hi-speed data transfer. In the HDD, surface recording density has increased at a high annual rate and still now further improvement in recording density is demanded.

In order to increase the recording density in the HDD, the width of a track and the length of a recording bit need to be reduced. However, if the width of the track is reduced, a so-called interference is liable to occur among the adjoining tracks. The interference collectively indicates phenomena such as overwriting information in a track adjacent to a track of writing target when recording, and causing crosstalk by magnetic field leakage from a track adjacent to a track of reproducing target when reproducing. These phenomena lower S/N ratio of reproduction signals and is responsible for worsening error rate.

On the other hand, promoting the reduction in the length of a recording bit generates a phenomenon of thermal fluctuation that deteriorates performance of storing recording bits for a long time.

Therefore, as methods of realizing a short bit length and a high track density while avoiding these interference and thermal fluctuation phenomena, a magnet disk of a bit-patterned type is proposed (for example, see Japanese Patent No. 1888363). In the bit-patterned type magnet disk, a position of a recording bit is predetermined. At the predetermined position of the recording bit, a dot made of a magnetic material is formed and a gap between dots is formed of a non-magnetic material. In this way, by separating the dots made of the magnetic material from each other, magnetic interference among the dots becomes small, thereby avoiding the interference and thermal fluctuation phenomenon.

### PATENT CITATION

Patent Citation 1: Japanese Patent No. 1888363

### DISCLOSURE OF INVENTION

### Technical Problem

Here, as a manufacturing method of the bit-patterned type magnetic recording medium, explanation will be made about a conventional manufacturing method proposed in the above-described Japanese Patent No. 1888363 or the like.

FIG. 1 illustrates a conventional manufacturing method of a bit-patterned type magnetic recording medium.

In the conventional manufacturing method, firstly, in a film-forming step (A), a magnetic film 2 is formed on a substrate 1.

Next, in a nanoimprint step (B), a resist 3 made of an ultraviolet cure resin is applied on the magnetic film 2, a mold 4 having nano-sized holes 4a is placed on the resist 3 so that the resist 3 enters into the nano-sized holes 4a to become dots 3a of the resist 3. Then, the resist 3 is irradiated with ultraviolet rays through the mold 4 so that the resist 3 is cured, which imprints the dots 3a on the magnetic film 2. After the resist 3 is cured, the mold 4 is removed.

After that, etching is performed in an etching step (C), which removes the magnetic film 2 while leaving magnetic dots 2a protected with the dots 3a of the resist 3. After the etching, the dots 3a of the resist 3 are removed by chemical treatment, thereby leaving only the magnetic dots 2a on the substrate 1.

In a filling step (D), a gap between the magnetic dots 2a is filled with a non-magnetic material and a surface thereof is smoothed in a smoothing step (E), thereby completing a bit-patterned type magnetic recording medium 6 in step (F).

According to such a conventional manufacturing method, in the smoothing step (E), a highly accurate smoothing needs to be performed to stabilize floating performance of a magnetic head on the magnetic recording medium 6. Therefore, there arises a problem that a very complicated manufacturing process may be required and that manufacturing cost increases.

To avoid these problems, a processing method that creates a separated state of dots by doping a magnetic film with ion to change magnetic state locally (ion doping method) is considered. Since magnetic property is changed by ion doping, no complicated manufacturing process of the etching, filling, and smoothing is needed, thereby substantially reducing manufacturing cost.

However, a simple application of the ion doping method is only effective in the reduction of magnetic anisotropy and almost ineffective in changing saturation magnetization. Therefore, the interference and thermal fluctuation phenomenon still remains and the ion doping method is not yet in practical use.

In view of the foregoing, it is an object according to an aspect of the invention to provide an easy manufacturing method with which it is possible to produce a bit-patterned type magnetic recording medium, a magnetic recording medium which has large a recording density and may be produced with the easy manufacturing method, and an information storage device.

### Technical Solution

According to an aspect of the invention, a manufacturing method of a magnetic recording medium in a basic mode includes:

forming a magnetic film having an artificial lattice structure by laminating plural types of atomic layers alternately on a substrate; and

separating dots, which forms a dot separation band by implanting an ion, to reduce saturation magnetization locally, into portions of the magnetic film other than plural portions thereof each becoming a magnetic dot in which information is to be magnetically recorded, the dot separation band having a saturation magnetization smaller than that of the magnetic dot.

According to another aspect of the invention, a magnetic recording medium in a basic mode includes:

a substrate;

plural magnetic dots provided on the substrate, each of the magnetic dots having an artificial lattice structure in which plural types of atomic layers are alternately laminated on the substrate, and information being magnetically recorded into each of the magnetic dots; and

a dot separation band provided between the magnetic dots, the dot separation band having an artificial lattice structure continuous to the artificial lattice structure of the magnetic dots, having a saturation magnetization smaller than that of the magnetic dots by an ion implanted into the artificial lattice structure of the dot separation band.

According to yet another aspect of the invention, an information storage device in a basic mode includes:

a magnetic recording medium including:
a substrate;
plural magnetic dots provided on the substrate, each of the magnetic dots having an artificial lattice structure in which plural types of atomic layers are alternately laminated on the substrate, and information being magnetically recorded into each of the magnetic dots; and
a dot separation band provided between the magnetic dots, the dot separation band having an artificial lattice structure continuous to the artificial lattice structure of the magnetic dots, having a saturation magnetization smaller than that of the magnetic dots by an ion implanted into the artificial lattice structure of the dot separation band;

a magnetic head that records and/or reproduces information magnetically onto and/or from the magnetic dots by closely approaching or by making contact with the magnetic recording medium; and

a head position control mechanism that moves the magnetic head relatively with respect to a surface of the magnetic recording medium and positions the magnetic head on a magnetic dot as a target of information recording and/or reproducing by the magnetic head.

According to the aspects of the manufacturing method of a magnetic recording medium, the magnetic recording medium, and the information storage device, it is possible to realize an easy manufacturing method, since the dot separation band is formed by ion implantation, thereby eliminating the need for complicated manufacturing process such as the etching, filling, and smoothing. Furthermore, the implantation of ion into the magnetic film having the artificial lattice structure lowers saturation magnetization enough so that the bit-patterned type magnetic recording medium with high recording density can be actually manufactured.

### Advantageous Effects

As explained above, according to the basic modes of the manufacturing method of a magnetic recording medium, the magnetic recording medium, and the information storage device, it is possible to realize the magnetic recording medium with high recording density in an easy manufacturing method.

### BRIEF DESCRIPTION OF DRAWINGS

FIG. 1 illustrates a conventional manufacturing method of a bit-patterned type magnetic recording medium.

FIG. 2 illustrates an internal structure of a hard disk device (HDD) as a specific embodiment of an information storage device.

FIG. 3 is a perspective view schematically illustrating a structure of a bit-patterned type magnetic recording disk.

FIG. 4 illustrates a specific embodiment of a manufacturing method of the magnetic recording medium, in contrast to the basic mode of the manufacturing method.

FIG. 5 is a drawing of a first exemplary embodiment.

FIG. 6 is a graph illustrating the effect of ion implantation on coercivity in the first and second exemplary embodiments.

FIG. 7 is a graph illustrating the effect of ion implantation on saturation magnetization in the first and second exemplary embodiments.

FIG. 8 is a graph illustrating the effect of ion implantation in the third and fourth exemplary embodiments.

FIG. 9 is a graph illustrating the effect of ion implantation in the third and fourth exemplary embodiments, and in various types of modification examples.

FIG. 10 is a graph illustrating the effect of ion implantation on coercivity in a comparative example.

FIG. 11 is a graph illustrating the effect of ion implantation on saturation magnetization in a comparative example.

FIG. 12 illustrates a confirmation result of magnetic dots by MFM.

### BEST MODE FOR CARRYING OUT THE INVENTION

Hereafter, specific embodiments will be described with reference to drawings, in contrast to the basic modes of the manufacturing method of a magnetic recording medium, the magnetic recording medium, and the information storage device explained in SUMMARY.

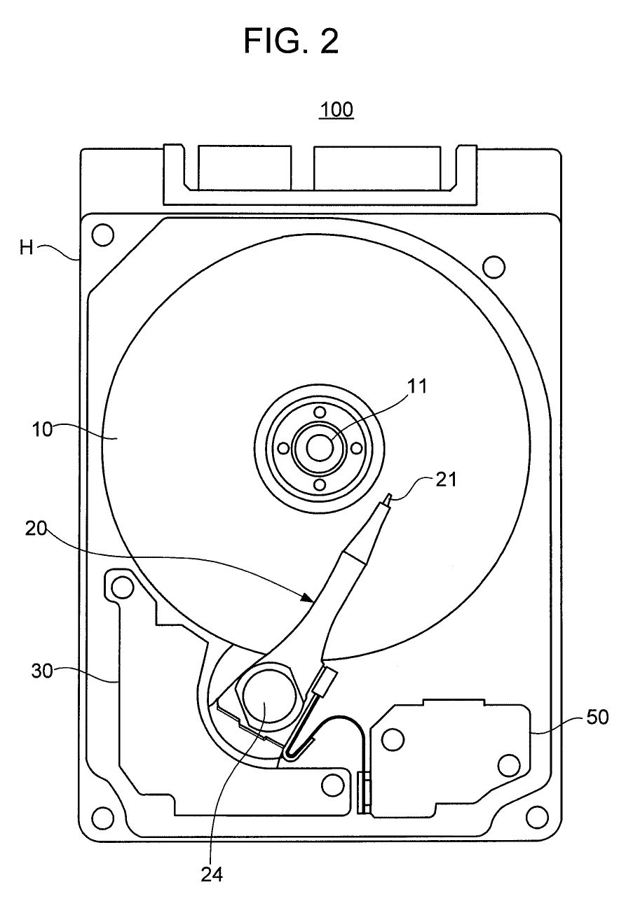

FIG. 2 illustrates an internal structure of a hard disk device (HDD) as a specific embodiment of the information storage device.

A HDD 100 illustrated in FIG. 2 is incorporated into an upper device like a personal computer to be used as an information storage section in the upper device.

In the HDD 100, plural disc-shaped magnetic disks 10 are housed in a housing H in a state of overlapping one another in the depth direction of FIG. 2. The magnetic disks 10 are so-called perpendicular magnetic recording media in which information is recorded by a magnetic pattern of magnetization in a direction perpendicular to the front and back surfaces of the magnetic disks. The magnetic disks 10 are also so-called bit-patterned type magnetic recording media in which dots for recording bit information therein are previously formed on locations on the front and back surfaces. The magnetic disks 10 rotate about a disk axis 11, and correspond to a specific embodiment of the magnetic recording medium of which basic mode has been described in SUMMARY.

In the housing H of the HDD 100, there are also incorporated a swing arm 20 that moves along the front and back surfaces of the magnetic disks 10, an actuator 30 used to drive the swing arm 20, and a control circuit 50.

The swing arm 20 mounts on its tip a magnetic head 21 that writes and reads information onto and/or from the front and back surfaces of the magnetic disks 10, and is pivotably supported by a bearing 24 to the housing H. The swing arm 20 moves the magnetic head 21 along the front and back surfaces of the magnetic disks 10 by pivotably moving within predetermined angles having the bearing 24 as the center. The magnetic head 21 corresponds to an example of the magnetic head in the basic mode of the information storage device.

Writing/reading of information by the magnetic head 21 and movement of the arm 30 are controlled by the control circuit 50, and communicating information with an upper device is also performed through the control circuit 50. The control circuit 50 corresponds to an example of the head position control mechanism in the basic mode of the information storage device.

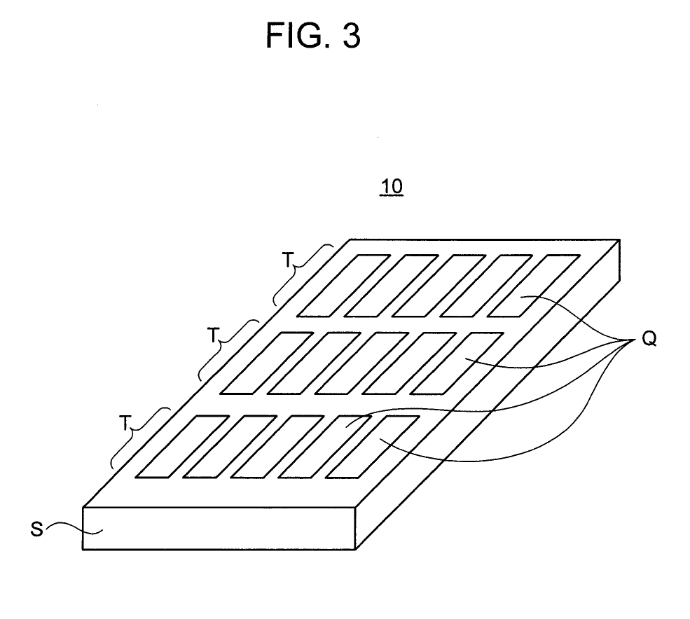

FIG. 3 is a perspective view schematically illustrating a structure of a bit-patterned type magnetic recording disk.

In FIG. 3, a portion cut out from a disc-shaped magnetic disk is illustrated.

The magnetic disk 10 of FIG. 3 has a structure in which plural recording dots Q are systematically arranged on a substrate S, and information equal to 1 bit is magnetically recorded in the respective recording dots Q. The recording dots Q are concentrically arranged around the center of the magnetic disk 10, and a row of the recording dots Q forms a track T.

A gap between the recording dots Q is made into a separation band of which magnetic anisotropy and saturation magnetization are lower than those of the recording dots Q, and by the separation band, magnetic interaction between the recording dots Q is made small.

In this way, if the magnetic interaction between the recording dots Q is small, then magnetic interaction between the tracks T also becomes small when recording/reproducing information onto and/or from the recording dots Q is performed, resulting in so-called less interference between the tracks. In addition, since location of the recording dots Q are physically fixed like this, a boundary of information bits to be recorded does not fluctuate thermally, thereby avoiding the so-called thermal fluctuation phenomenon. As a result, according to the bit-patterned type magnetic disk 10 in FIG. 3, it is possible to reduce the width of the tracks and to shorten the length of the recording bits, thereby realizing the magnetic recording medium with high recording density.

In the following, a manufacturing method of the magnetic recording medium 10 is explained.

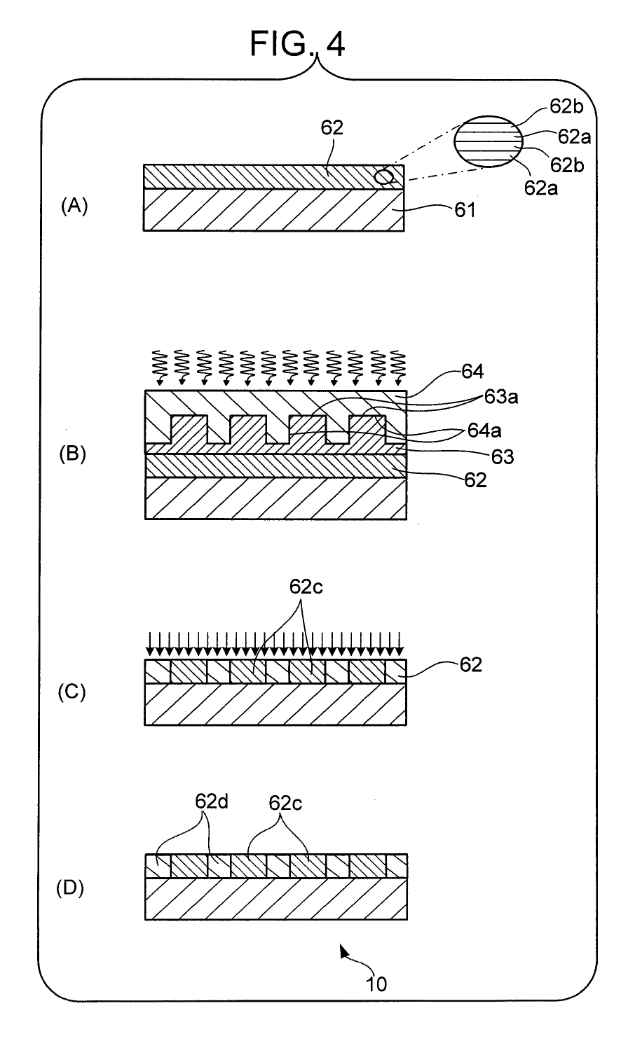

FIG. 4 illustrates a specific embodiment of the manufacturing method of the magnetic recording medium of which basic mode has been described.

In contrast to the basic mode of the manufacturing method of a magnetic recording medium described in SUMMARY, it is preferable to employ an application mode that “the manufacturing method of a magnetic recording medium further includes: forming a mask on the magnetic film, at the plurality of portions each becoming the magnetic dot, the mask blocking ion dope in the magnetic dot, wherein the separating dots irradiates an ion from above the magnetic film on which the mask is formed at the plurality of portions and implants the ion locally in a portion between the magnetic dots protected with the mask”. According to this application mode, since the portions where ion implantation is unnecessary are surely protected with the masks, thereby achieving high accuracy in forming the magnetic dots. A specific embodiment to be explained in the following is also a concrete embodiment of such a preferable application mode.

By the manufacturing method of FIG. 4, the magnetic disk 10 of FIGS. 2 and 3 is produced.

In the manufacturing method of FIG. 4, firstly, in the film-forming step (A), a magnetic film 62 is formed on a glass substrate 61. This film-forming step (A) corresponds to an example of the step of forming a magnetic film having an artificial lattice structure in the basic mode of the manufacturing method of a magnetic recording medium. The magnetic film 62 has a structure of artificial lattice in which a Co atomic layer 62a and a Pd atomic layer 62b are alternately laminated. In the combination of the Co atomic layer 62a and the Pd atomic layer 62b, the thickness of the Pd atomic layer 62b needs to be larger than the thickness of the Co atomic layer 62a to form the magnetic film 62. Additionally, an upper limit of 2 nm is set to the Co atomic layer 62a in the thickness of film, and that thickness of film is substantially equivalent to the thickness of 7 atoms. If the Co atomic layer 62a has the thickness of film exceeding this upper limit, then it is considered that physical characteristics corresponding to the artificial lattice are also lost.

In the basic modes of the manufacturing method of a magnetic recording medium, the magnetic recording medium, and the information storage device, it is preferable that the artificial lattice structure has a structure in which a Co atomic layer and a PGM (Platinum Group Metals) atomic layer are alternately laminated, or has a structure in which a Co atomic layer and a Pd atomic layer are alternately laminated. This is because a magnetic film with the artificial lattice structure formed by alternately laminating the Co atomic layer and the PGM atomic layer has excellent magnetic property as well as allowing deterioration of the magnetic property readily by the after-mentioned ion implantation. A magnetic film with the artificial lattice structure formed by alternately laminating the Co atomic layer and the Pd atomic layer further excels in the magnetic property. The artificial lattice structure formed in the film-forming step (A) corresponds to an example of the preferable artificial lattice structure.

Note that materials to form a magnetic film having the artificial lattice structure in the basic modes are not limited to the preferable materials described here, and any materials known to be capable of forming the magnetic film with the artificial lattice structure can be used. However, in the following explanation, it is assumed that the magnetic film is formed of Co and Pd.

Next, in the nanoimprint step (B), a resist 63 made of an ultraviolet cure resin is applied on the magnetic film 62, then a mold 64 having nano-sized holes 64a is placed on the resist 63 so that the resist 63 enters into the nano-sized holes 64a to become dots 63a of the resist 63. Thereafter, the resist 63 is irradiated with ultraviolet rays through the mold 64 to cure the resist 63, which imprints the dots 63a on the magnetic film 62. After the resist 63 is cured, the mold 64 is removed.

Here, an application mode that “the forming a mask forms the mask by resist” is preferable to the basic mode of the manufacturing method of a magnetic recording medium. And an application mode that “the forming a mask forms the mask by resist with the use of nanoimprint process” is further preferable. Forming a mask by resist is favorable, since it enables easy creation of mask patterns in nano level. The nanoimprint step (B) of FIG. 4 corresponds to an example of the step of forming a mask in these preferable application modes.

Following the nanoimprint step (B), the procedure continues to an ion implantation step (C). In the ion implantation step (C), oxygen ion or nitrogen ion is irradiated from above the magnetic film 62 on which the dots 63a are imprinted, to implant the ion in the magnetic film 62 so as to reduce saturation magnetization, while leaving magnetic dots 62c protected by the dots 63a of the resist 63. Since the magnetic film 62 has the artificial lattice structure, the saturation magnetization of the magnetic film 62 can be effectively reduced by the ion implantation. The nanoimprint step (B) corresponds to an example of the step of separating dots in the basic mode of the manufacturing method of a magnetic recording medium. Here, in the basic modes of the manufacturing method of a magnetic recording medium, the magnetic recording medium, and the information storage device, it is preferable to employ an application mode that “the separating dots uses at least either oxygen ion or nitrogen ion as the ion”. This is because the oxygen ion and the nitrogen ion can reduce magnetic property of the magnetic film more effectively than when other ions are implanted in the artificial lattice structure.

Additionally, in the nanoimprint, the resist is not completely removed even in portions where the ion is implanted. However, at a portion where the resist is thin, the ion passes through the resist and are implanted into the magnetic film 62, whereas at a portion where the resist is thick (i.e., a portion that is made into the dot 63a), the ion is stopped at the resist without reaching the magnetic film, thereby enabling formation of a desired dot pattern. Acceleration voltage of ion is set so as to enable ion implantation in a center portion of the magnetic film 62, but the acceleration voltage to be set varies depending on a type of ions and also varies depending on the depth to the center portion of the magnetic film and on a material of the magnetic film. The portions of the magnetic film 62 where the ion is implanted reduces its coercive force and saturation magnetization by distortion in the artificial lattice structure due to accumulation of the ion inside the artificial lattice structure. After the ion implantation, the dots 63a of the resist are removed by chemical treatment.

Through the ion implantation step (C) like this, a separation band 62d that separates magnetic interference among the magnetic dots 62c is formed in a gap between the magnetic dots 62c, and the bit-patterned type magnetic recording medium 10 is completed in step (D). In the separation band 62d, saturation magnetization is lower than that of the magnetic dots 62c, thereby information is only recorded in the magnetic dots 62c and not recorded in the separation band 62d.

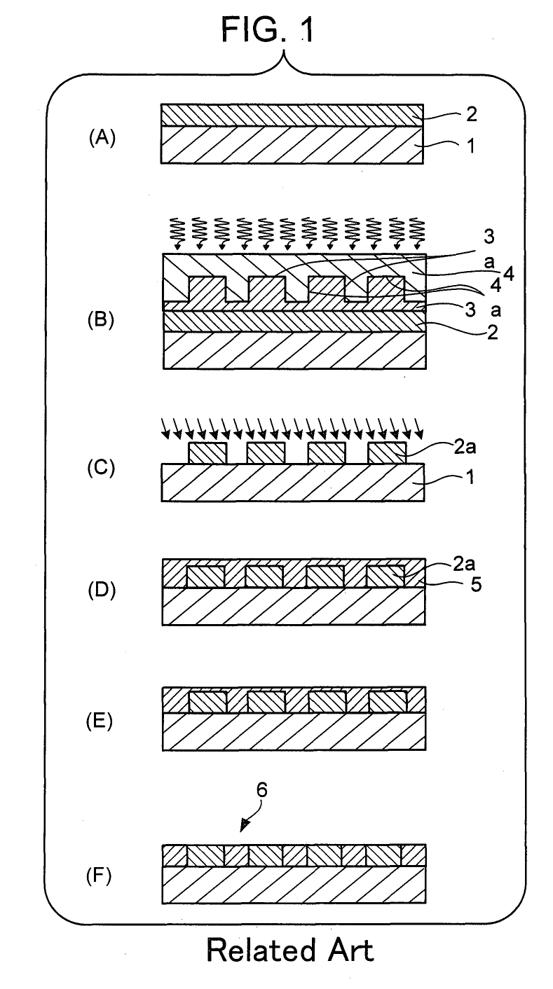

In the magnetic recording medium 10 produced by the manufacturing method illustrated in FIG. 4, smoothness of the magnetic film 62 formed in the film-forming step (A) is maintained as it is, as smoothness between the magnetic dot 62c and the separation band 62d forming the surface of magnetic recording medium 10. Therefore, the smoothing step in the conventional technique illustrated in FIG. 1 becomes unnecessary, and consequently, the manufacturing method illustrated in FIG. 4 is simplified.

In addition, in the manufacturing method in FIG. 4, the magnetic dots 62c are protected by the dots 63a of the resist imprinted on the magnetic film 62, thereby enabling ion radiation on a whole surface of the magnetic recording medium 10 at the same time, which can realize the ion implantation into necessary portions well by irradiating ion for a few seconds, without hindering productivity.

In the following exemplary embodiments, technical effects are verified by applying the manufacturing method illustrated in FIG. 4 to a specific material or the like.

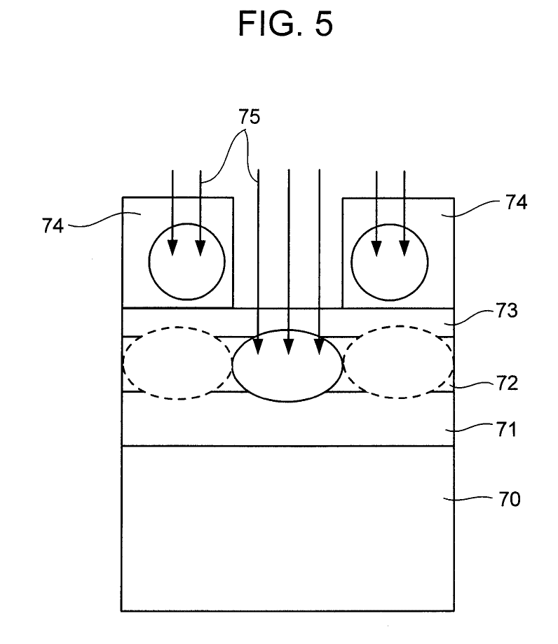

FIG. 5 is a drawing of a first exemplary embodiment.

A well-cleaned glass substrate 70 is set in a magnetron sputter unit and subjected to vacuum pumping to 5×10⁻⁵ Pa or less, then without heating the glass substrate 70, fcc-pd that is (111) crystalline-oriented at Ar gas pressure of 7 Pa is formed in the thickness of 10 nm as a base layer 71 to direct crystalline-orientation of a magnetic layer. Explanation of the step of forming the base layer 71 is omitted in the manufacturing method illustrated in FIG. 4.

Then, successively, without restoring to atmospheric pressure, a magnetic film 72 formed of a Co/Pd artificial lattice is repeatedly laminated in 16 layers such that the film is structured to have the Co/Pd thickness of 0.3/0.35 nm at Ar gas pressure of 0.67 Pa. This structure of film thickness means an artificial lattice in which a single atomic layer of Co and a single atomic layer of Pd are repeated, and the total film thickness of the magnetic film 72 is 10.4 nm.

After the formation of the magnetic film 72, diamond carbon is formed in the thickness of 3 nm as a protection layer 73. Explanation of the step of forming the protection layer 73 is also omitted in the manufacturing method illustrated in FIG. 4.

A resist is applied on the protection film 73 and using the nanoimprint process, a columnar resist pattern 74 measuring 140 nm in diameter is formed.

A N²⁺ ion 75 accelerated to 6 keV is irradiated from above the pattern 74 so as to be implanted into the magnetic film 72. As described above, the acceleration voltage of the ion is set so that the ion is implanted into the center portion of magnetic film 72. As a result of SIMS analysis, it is confirmed that the ion is implanted to an exact depth specified as a set value.

Following the ion implantation, the resist pattern 74 is removed by SCI cleaning, and the first exemplary embodiment is obtained.

In contrast to the first exemplary embodiment, a second exemplary embodiment is obtained by reducing the repetition of the artificial layers in the magnetic film in half, thereby forming the magnetic film in 8 layers having the film thickness of 5.2 nm.

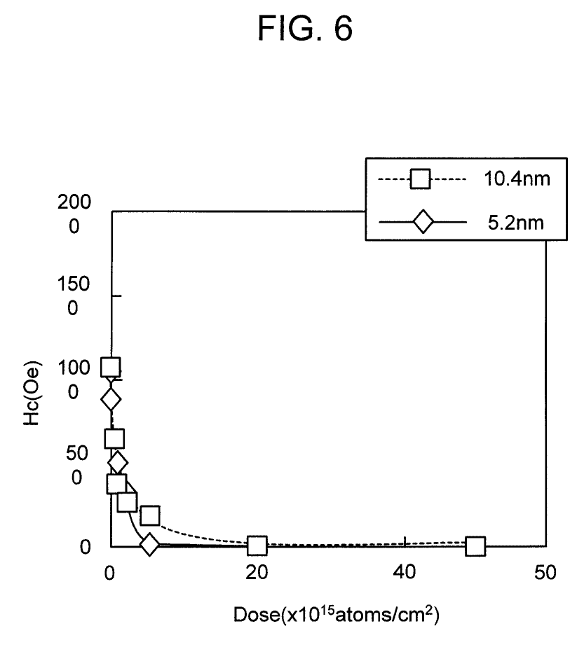

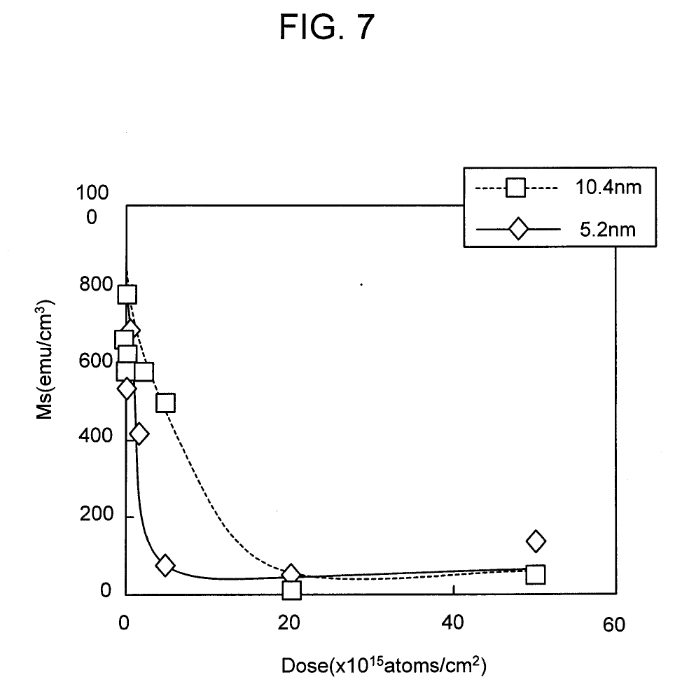

FIGS. 6, 7 are graphs illustrating the effect of ion implantation in the first and second exemplary embodiments. Horizontal lines in FIGS. 6, 7 denote the dose of ion implantation, whereas vertical line in FIG. 6 denotes coercive force and vertical line in FIG. 7 denotes saturation magnetization.

As illustrated in these graphs, it is confirmed that in both of the first exemplary embodiment in which the magnetic film has the thickness of 10.4 nm (a graph of a dotted line) and the second exemplary embodiment in which the magnetic film has the thickness of 5.2 nm (a graph of a solid line), the coercive force and the saturation magnetization are drastically reduced when the dose of ion implantation is 1×10¹⁶ (atoms/cm²) or less. That is, by implanting the ion into the magnetic film having the artificial lattice structure, magnetic interferences among the magnetic dots can be effectively reduced. Incidentally, if the dose of ion implantation reaches to 2×10¹⁶ (atoms/cm²) or more, then the thickness of the magnetic film is reduced by the ion implantation, causing disruption of smoothness on the surface of the recording medium. Therefore, it is better to control the dose of ion implantation in less than 2×10¹⁶ (atoms/cm²), or more preferably in 1×10¹⁶ (atoms/cm²) or less.

In contrast to the first and second exemplary embodiments, a third exemplary embodiment in which the total thickness of the film is 20.0 nm is obtained. It is obtained by repeatedly laminating a Co/Pd artificial lattice in the film structure having the Co/Pd thickness of 0.3/0.7 nm in 20 layers (i.e., artificial lattice in which a single atomic layer of Co and two atomic layers of Pd are repeated). In contrast to the third exemplary embodiment like this, a fourth exemplary embodiment is obtained by changing a type of ion to be implanted to O²⁺ ion. In this case, the ion implantation into the center portion of the magnetic film is realized by the acceleration voltage of the ion at 22 keV (N²⁺), 24 keV (O²⁺).

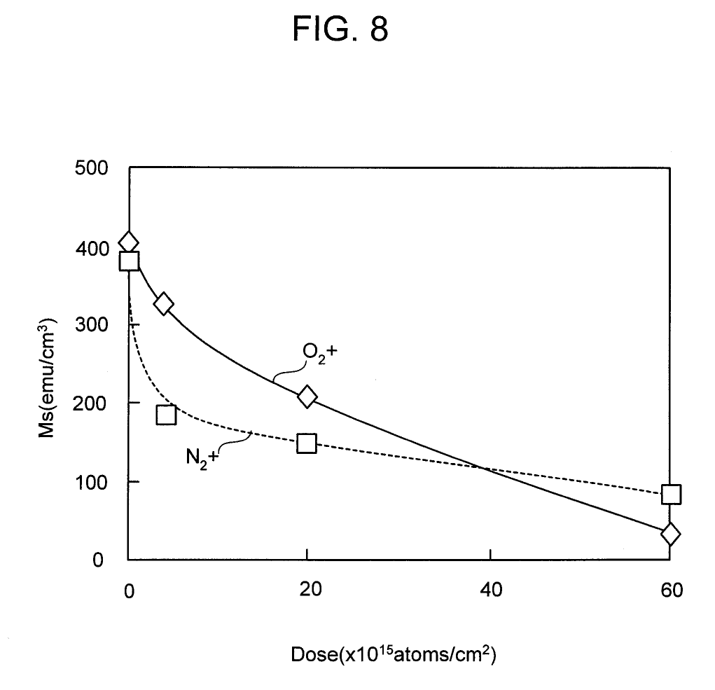

FIG. 8 is a graph illustrating the effect of ion implantation in the third and fourth exemplary embodiments.

A horizontal line in FIG. 8 denotes the dose of ion implantation, and a vertical line denotes saturation magnetization.

As illustrated in FIG. 8, it is confirmed that also in both of the third (a graph of dotted line) and fourth (a graph of solid line) exemplary embodiments in which the film thickness or the type of ion is different from that in the first and second exemplary embodiments, the saturation magnetization is drastically reduced when the dose of ion implantation is 1×10¹⁶ (atoms/cm²) or less. That is, it is confirmed that employing a structure that ion is implanted into the magnetic film having the artificial lattice structure can create a separation band that magnetically divides magnetic dots.

Furthermore, the effect of ion implantation is verified in detail by obtaining various types of modification examples by changing a type of ions to be implanted, while having the same film thickness structure as in the third and the fourth exemplary embodiments.

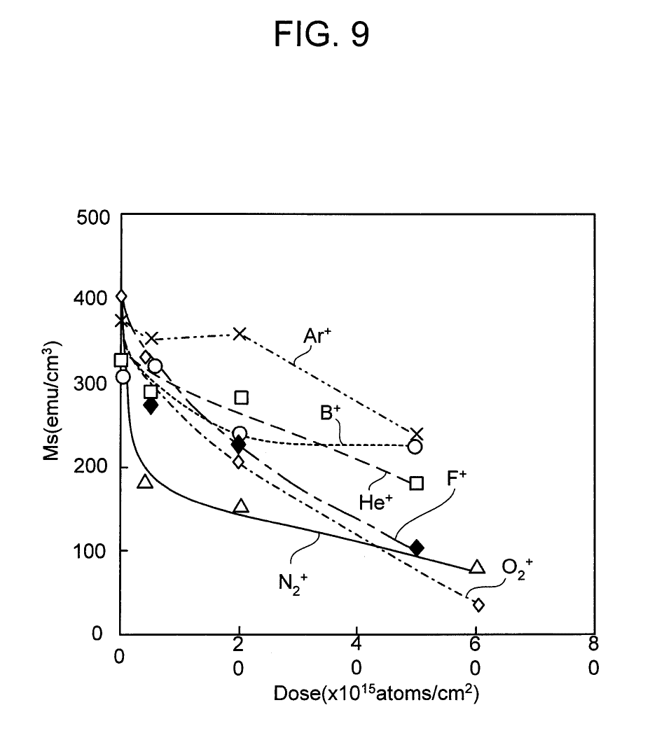

FIG. 9 is a graph illustrating the effect of ion implantation in the third and fourth exemplary embodiments, and various types of modification examples.

Also in FIG. 9, a horizontal line denotes the dose of ion implantation, and a vertical line denotes saturation magnetization.

In FIG. 9, the graph of the above-described third and fourth exemplary embodiments is again illustrated. FIG. 9 also illustrates graphs of four types of modification examples in which types of ion implanted is any of F⁺, He⁺, B⁺, and Ar⁺. Either of the graphs of the modification examples indicates a basic tendency that the saturation magnetization is drastically reduced when the dose of ion implantation is 1×10¹⁶ (atoms/cm²) or less. However, viewing from a reduction rate with respect to the saturation magnetization when the dose of ion implantation is zero, it is known that N²⁺ and O²⁺ exhibit superiority over the other types of ion.

In contrast to the above-described exemplary embodiments and modification examples, as a comparative example, a magnetic film having no artificial lattice structure, implanted with ion is created and the effect of the ion implantation in the comparative example is checked.

In the comparative example, on a glass substrate, a magnetic film is formed of a Ta layer in the thickness of 3 nm and a Ru layer in the thickness of 10 nm, followed by an alloy of CoCrPt (Co79Cr3Pt18) formed thereon in the thickness of 20 nm. Further, diamond carbon in the thickness of 3 nm is applied thereon as a protection layer and the ion (N²⁺ and O²⁺) are implanted therein by radiation.

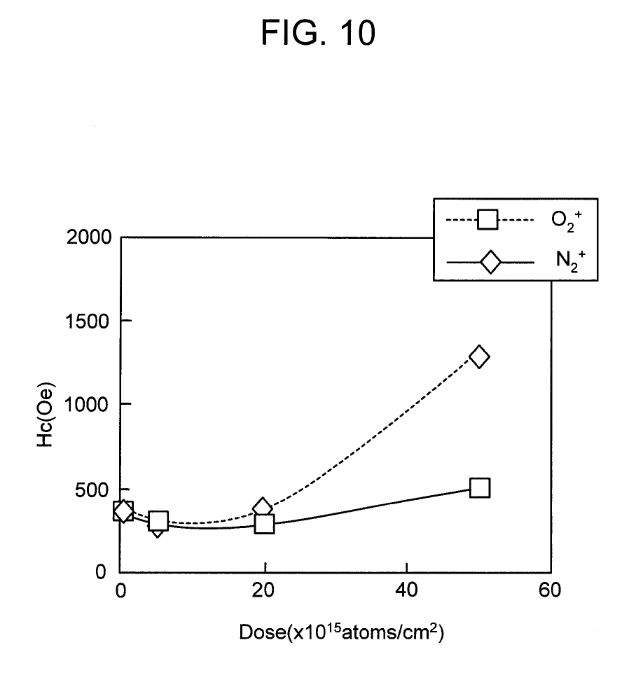

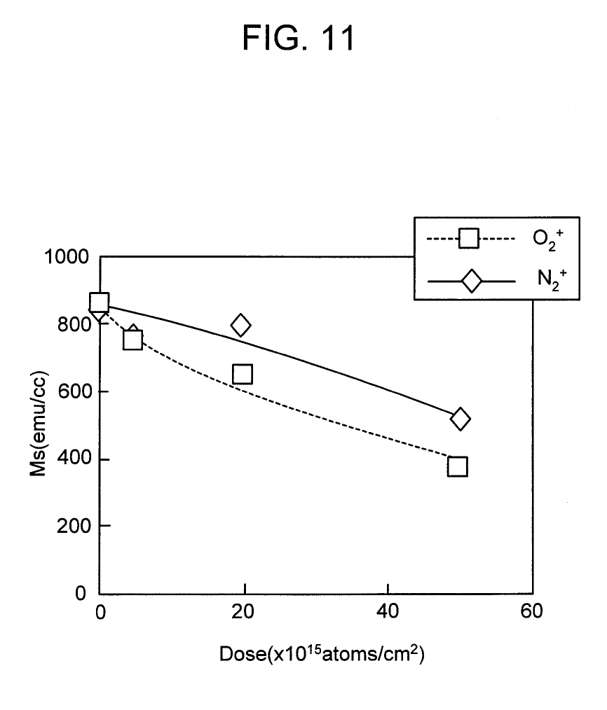

FIGS. 10, 11 are graphs illustrating the effect of the ion implantation in the comparative example. In FIGS. 10 and 11, a horizontal line denotes the dose of ion implantation, whereas a vertical line in FIG. 10 denotes coercive force and a vertical line in FIG. 11 denotes saturation magnetization.

The thickness of the magnetic film and the type of ion in the comparative example is similar to those of the third and fourth exemplary embodiments. However, as the graphs in FIGS. 10 and 11 illustrate, in the comparative example, the reduction in the coercive force and saturation magnetization by the ion implantation is small, and it is confirmed that the ion implantation is not effective in the magnetic film having no artificial lattice structure.

Finally, it is confirmed that the magnetic dots are actually formed in the first exemplary embodiment through the measurement using a MFM (Magnetic Force Microscope).

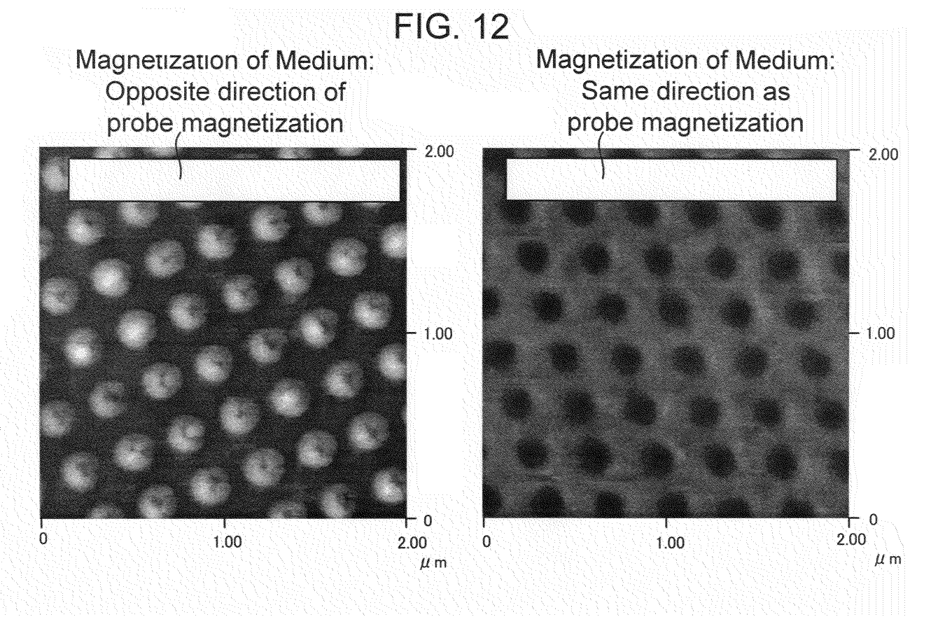

FIG. 12 illustrates a confirmation result of the magnetic dots by MFM.

Here, a uniform magnetic field of 20 kOe is applied by an electromagnet to the magnetic recording medium of the first exemplary embodiment in a direction perpendicular to the magnetic recording medium to cause magnetization, and a magnetic state on the surface of the magnetic recording medium is measured by the MFM.

On the left side of FIG. 12, a measured result when the magnetic recording medium is magnetized with a magnetic field in a direction opposite to the direction of the probe magnetization of the MFM is illustrated. On the right side of FIG. 12, a measured result when the magnetic recording medium is magnetized with a magnetic field in the same direction as the direction of the probe magnetization of the MFM is illustrated. In both cases when the magnetic recording medium is magnetized in either of directions, it is confirmed that there is a clear difference in the magnetic state between a round magnetic dot and a separation band existing between the magnetic dots.

Incidentally, in the above explanation, the use of resist pattern is exemplified as a preferable mask to form a magnetic dot. However, in the basic modes of the ion implantation, a process may be used in which the ion implantation is performed by disposing a stencil mask very closely to a surface of a recording medium without touching the surface thereof. This process can eliminate the steps of applying resist and removing the resist. Moreover, in the above explanation, as a good example of resist patterning, the use of nanoimprint process is exemplified. However, electron-beam exposure may be used for patterning.

Additionally, it is preferable to implant ion into the center portion of the magnetic film, and control the depth of the ion implantation by changing acceleration voltage. It is no good to make the height of the implanted ion too low or too high. If the height is too low, it is impossible to reduce saturation magnetization well. If the height is too high, then damage is caused to the surface of the medium, resulting in not only impairing floating performance but also losing the magnetic film due to etching.

### REFERENCE SIGNS LIST

100 a hard disk device
10 magnetic disks
61a substrate
62 a magnetic film
62a a Co atomic layer
62b a Pd atomic layer
62c magnetic dots
62d a separation band

What is claimed is:

1. A manufacturing method of a magnetic recording medium, comprising:
forming a magnetic film having an artificial lattice structure by laminating a plurality of types of atomic layers alternately on a substrate; and
separating dots, which forms a dot separation band by implanting an ion, to reduce saturation magnetization locally, into portions of the magnetic film other than a plurality of portions thereof each becoming a magnetic dot in which information is to be magnetically recorded, the dot separation band having a saturation magnetization smaller than that of the magnetic dot.

2. The manufacturing method of a magnetic recording medium according to claim 1, further comprising:
forming a mask on the magnetic film, at the plurality of portions each becoming the magnetic dot, the mask blocking ion dope in the magnetic dot,
wherein the separating dots irradiates an ion from above the magnetic film on which the mask is formed at the plurality of portions and implants the ion locally in a portion between the magnetic dots protected with the mask.

3. The manufacturing method of a magnetic recording medium according to claim 1, wherein the forming forms a magnetic film having an artificial lattice structure by laminating a Co atomic layer and a PGM (Platinum Group Metals) atomic layer alternately.

4. The manufacturing method of a magnetic recording medium according to claim 1, wherein the forming forms a magnetic film having an artificial lattice structure by laminating a Co atomic layer and a Pd atomic layer alternately.

5. The manufacturing method of a magnetic recording medium according to claim 1, wherein the separating dots uses at least either oxygen ion or nitrogen ion as the ion.

6. The manufacturing method of a magnetic recording medium according to claim 2, wherein the forming a mask forms the mask by resist.

7. The manufacturing method of a magnetic recording medium according to claim 2, wherein the forming a mask forms the mask by resist with the use of nanoimprint process.

8. A magnetic recording medium, comprising:
a substrate;
a plurality of magnetic dots provided on the substrate, each of the magnetic dots having an artificial lattice structure in which a plurality of types of atomic layers are alternately laminated on the substrate, and information being magnetically recorded into each of the magnetic dots; and
a dot separation band provided between the magnetic dots, the dot separation band having an artificial lattice structure continuous to the artificial lattice structure of the magnetic dots, having a saturation magnetization smaller than that of the magnetic dots by an ion implanted into the artificial lattice structure of the dot separation band.

9. The magnetic recording medium according to claim 8, wherein the artificial lattice structure is a lamination in which a Co atomic layer and a PGM (Platinum Group Metals) atomic layer are alternately laminated.

10. The magnetic recording medium according to claim 8, wherein the artificial lattice structure is a lamination in which a Co atomic layer and a Pd atomic layer are alternately laminated.

11. The magnetic recording medium according to claim 8, wherein the dot separation band is implanted with at least either oxygen ion or nitrogen ion as the ion.

12. An information storage device, comprising:
a magnetic recording medium comprising:
a substrate;
a plurality of magnetic dots provided on the substrate, each of the magnetic dots having an artificial lattice structure in which a plurality of types of atomic layers are alternately laminated on the substrate, and information being magnetically recorded into each of the magnetic dots; and
a dot separation band provided between the magnetic dots, the dot separation band having an artificial lattice structure continuous to the artificial lattice structure of the magnetic dots, having a saturation magnetization smaller than that of the magnetic dots by an ion implanted into the artificial lattice structure of the dot separation band;
a magnetic head that records and/or reproduces information magnetically onto and/or from the magnetic dots by closely approaching or by making contact with the magnetic recording medium; and
a head position control mechanism that moves the magnetic head relatively with respect to a surface of the magnetic recording medium and positions the magnetic head on a magnetic dot as a target of information recording and/or reproducing by the magnetic head.

13. The information storage device according to claim 9, wherein the artificial lattice structure is a lamination in which a Co atomic layer and a PGM (Platinum Group Metals) atomic layer are alternately laminated.

14. The information storage device according to claim 9, wherein the artificial lattice structure is a lamination in which a Co atomic layer and a Pd atomic layer are alternately laminated.

15. The information storage device according to claim 9, wherein the dot separation band is implanted with at least either oxygen ion or nitrogen ion as the ion.
